(19) United States
(12) Patent Application Publication
(10) Pub. No.: US 2002/0063169 A1
(43) Pub. Date: May 30, 2002

(54) Wafer spray configurations for a single wafer processing apparatus

(75) Inventors: Steven Verhaverbeke, San Francisco, CA (US); J. Kelly Truman, Morgan Hill, CA (US)

Correspondence Address: Michael A. Bernadicou, APPLIED MATERIALS, INC., Patent Counsel, Legal Affairs Department, P.O. Box 450A, Santa Clara, CA, 95052, US

(73) Assignee: APPLIED MATERIALS, INC.

(21) Appl. No.: 09/891,791

(22) Filed: Jun. 25, 2001

Related U.S. Application Data
(60) Provisional application No. 60/214,055, filed on Jun. 26, 2000.

(51) Int. Cl. A62C 31/00; B05B 1/00; A62C 31/02

(52) U.S. Cl. 239/436; 239/440; 239/441; 239/599; 239/601

(57) ABSTRACT

The present invention is a single wafer process apparatus which includes a rotatable wafer support for rotating a wafer about its central axis. Additionally, the single wafer processing apparatus includes a plurality of liquid spray nozzles for creating a spray pattern of liquid onto a wafer located on the wafer support wherein the entire surface of the wafer is covered with the spray pattern.

This application claims the benefit of provisional application Ser. No. 60/214,055 filed Jun. 26, 2000 entitled WAFER SPRAY CONFIGURATIONS FOR A SINGLE WAFER PROCESSING APPARATUS.

### BACKGROUND OF THE INVENTION

1. Field of the Invention

The present invention relates to the field of semiconductor processing and more specifically to a method and apparatus for spraying liquid chemicals such as etchants and cleaning solutions onto a wafer in a single wafer wet processing apparatus.

2. Discussion of Related Art

Wet etching and wet cleaning of silicon wafers is usually done by immersing the wafers into a liquid. This can also be done by spraying a liquid onto a wafer or batch of wafers. Wet wafer cleaning and etching is traditionally done in a batch mode where between 50-100 wafers are processed simultaneously. Because of the need for shorter cycle times in chip manufacturing there is a need for fast single wafer processing.

When using fast single wafer processing, current state of the art uses a dispenser or spray at the center of the wafer. The liquid flows from the center to the edges as a result of centrifugal force when spinning the wafer at the same time. However, a problem with this method is that the center of the wafer is exposed longer than the edge of the wafer. Even though the difference in exposure can be very short, it can detrimentally affect the uniformity of the etching or cleaning process. When using single wafer processing and trying to achieve high throughput very short etches such as, 5 seconds or 10 seconds, need to be performed with the same etching uniformity as a batch tool or with even better uniformity. Typical total uniformity of etching process has to be lower than 1%-1 sigma. Such variations is a result of temperature variations, concentration variations, and exposure variations. As a first approximation, one can allot equal variations for temperature, concentration and exposure. This means that the exposure variations have to be less than 0.3%-1 sigma. In the extreme case of a short, a 5 second etch, this means 0.015 second difference in exposure of any two points on a wafer is allowable. Unfortunately, this cannot presently be achieved with a center spray or dispense.

### SUMMARY OF THE INVENTION

The present invention is a single wafer process apparatus which includes a rotatable wafer support for rotating a wafer about its central axis. Additionally, the single wafer processing apparatus includes a plurality of liquid spray nozzles for creating a spray pattern of liquid onto a wafer located on the wafer support wherein the entire surface of the wafer is covered with the spray pattern.

### BRIEF DESCRIPTION OF THE DRAWINGS

FIG. 1a is an illustration of a cross-sectional view of a single wafer wet processing apparatus.

FIG. 1b is an illustration showing the covering of the entire surface area of a plate with transducers.

FIG. 1c is an illustration showing how the transducer covered plate of FIG. 1b covers the entire surface area of a wafer being processed.

FIG. 2a is an illustration showing the spray pattern created with a plurality of conical spray nozzles which cover the entire wafer surface.

FIG. 2b is an illustration showing the spray pattern of a conical spray nozzle.

FIG. 3 is an illustration showing the spray pattern created with a line covering the entire wafer diameter using flat spray nozzles.

FIG. 4 is an illustration showing the spray pattern with a line covering the wafer radius using flat spray nozzles.

FIG. 5 is an illustration showing the spray composed of a liquid spray with added gas flow atomization.

FIG. 6 is an illustration showing the combination of a liquid flow and gas in a venturi for added atomization.

### DETAILED DESCRIPTION OF THE PRESENT INVENTION

The present inventions are novel spray pattern configurations for a single wafer wet processing apparatus and their methods of use. In the following description numerous specific details are set forth in order to provide a thorough understanding of the present invention. One of ordinary skill of the art will appreciate that these specific details are for illustrative purposes only and are not intended to limit the scope of the present invention. Additionally, in other instances, well-known processing techniques and equipment have not been set forth in particular detail in order to not unnecessarily obscure the present invention.

The present invention is a plurality of different spray pattern configurations for a single wafer wet processing apparatus and their method of use. According to a preferred embodiment of the present invention a wafer is placed in a single wafer wet processing apparatus in which the wafer to be processed, is spun about its central axis. The single wafer wet processing apparatus contains a plurality of nozzles which create a spray pattern which covers the entire surface of the wafer. In this way, the entire wafer surface can be coated with liquid chemicals such as etchants and cleaning solution without requiring spinning of the wafer. Because the entire wafer surface is simultaneously coated with chemicals outstanding etching and cleaning uniformity can be achieved. Because the entire surface is exposed to chemicals, rotation rates can be reduced which in turn reduce the amount of chemicals consumed in the wet process. Additionally, in an embodiment of the present invention a gas is dissolved in the liquid to increase the atomization of the spray and thereby reduce chemical consumption.

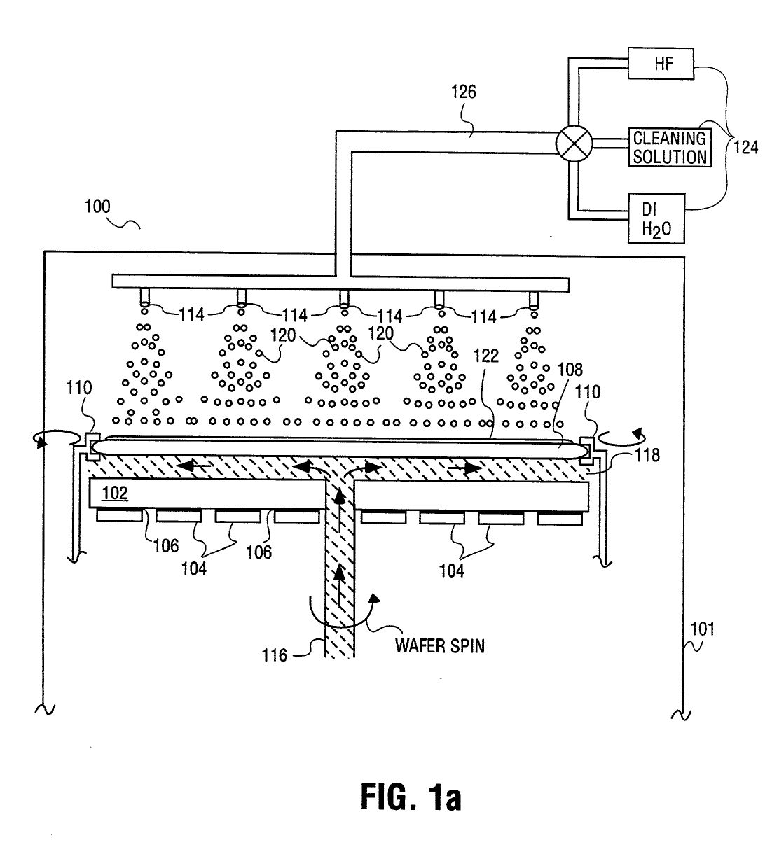

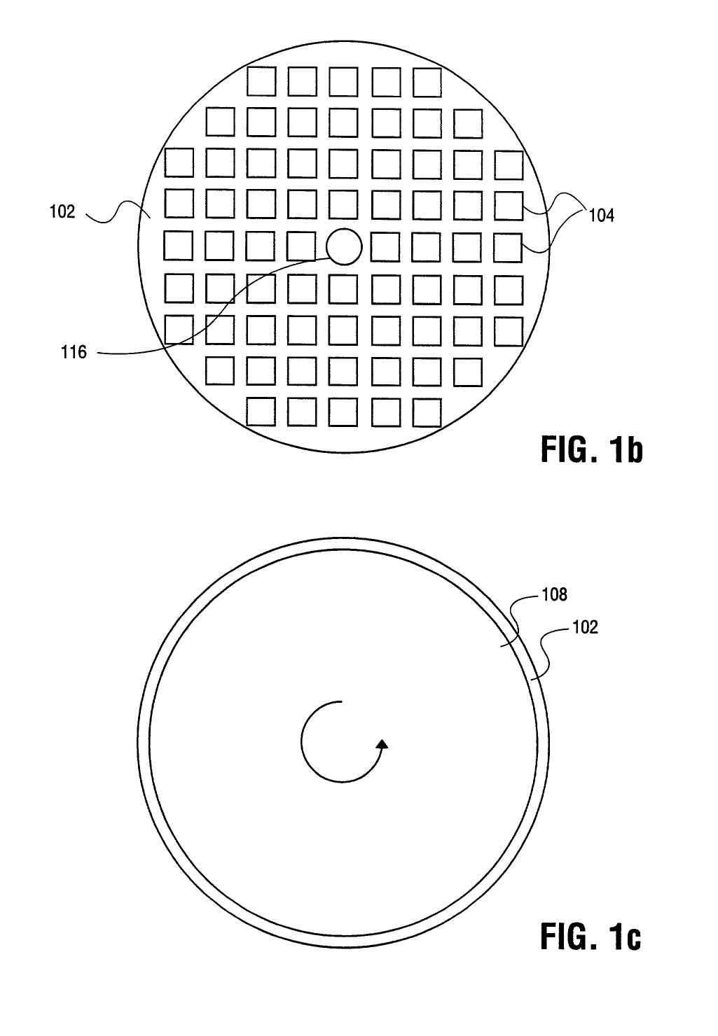

An example of a single wafer wet processing apparatus 100 in which the spray pattern configurations of the present invention can be implemented is shown in FIG. 1a. Single wafer wet processing apparatus 100 shown in FIG. 1a includes a plate 102 with a plurality of acoustic or sonic transducers 104 located thereon. Plate 102 is preferably made of aluminum but can be formed of other materials such as but not limited to stainless steel and sapphire. The plate is preferably coated with a corrosion resistant fluoropolymer such as Halar. The transducers 104 are attached to the bottom surface of plate 102 by an epoxy 106. The transducers 104 cover the entire bottom surface of plate 102 as shown in FIG. 1b. The transducers 100 preferably generate sonic waves in the frequency range between 400 kHz and 8 MHz. In an embodiment of the present invention the transducers are piezoelectric devices. The transducers 104 create acoustic or sonic waves in direction perpendicular to the surface of water 108.

A substrate or wafer 108 is held at distance of about 3 mm above the top surface of plate 102. The wafer 108 is clamped by a plurality of clamps 110 face up to a wafer support 112 which can rotate wafer 108 about at central axis. The wafer support can rotate or spin wafer 108 about its central axis at a rate between 0-6000 rpm. In apparatus 100 only wafer support 112 and wafer 108 are rotated during use whereas plate 102 remains in a fixed position. Additionally, in apparatus 100 wafer 108 is placed face up wherein the side of the wafer with patterns or features, such as transistors, faces towards nozzles 114 which spray cleaning or etching chemicals thereon and wherein the backside of the wafer faces plate 102. Additionally, as shown in FIG. 1c the transducer covered plate 102 has a substantially same shape as wafer 108 and covers the entire surface area of wafer 108. Apparatus 100 can include a sealable chamber 101 in which nozzles 114, wafer 108, and plate 102 are situated as shown in FIG. 1a.

During use, DI water (DI-H₂O) is fed through a feed through channel 116 and plate 102 and fills the gap between the backside of wafer 108 and plate 102 to provide a water filled gap 118 through which acoustic waves generated by transducers 104 can travel to substrate 108. In an embodiment of the present invention DI water fed between wafer 108 and plate 102 is degassed so that cavitation is reduced in the DI water filled gap 118 where the acoustic waves are strongest thereby reducing potential damage to wafer 108.

Additionally during use, cleaning chemicals such as SC-1 and SC-2, etchants such as diluted HF or buffered HF, and rinsing water such as DI-H₂O are fed through a plurality of nozzle 114 to generate a spray 120 of droplets which form a liquid coating 122 of for example about 100 microns on the top surface of wafer 108 while wafer 108 is spun. In the present invention tanks 124 containing wet processing chemicals such as diluted HF, de-ionized water (DI-H₂O), and cleaning solutions are coupled by conduit 126 to nozzles 114.

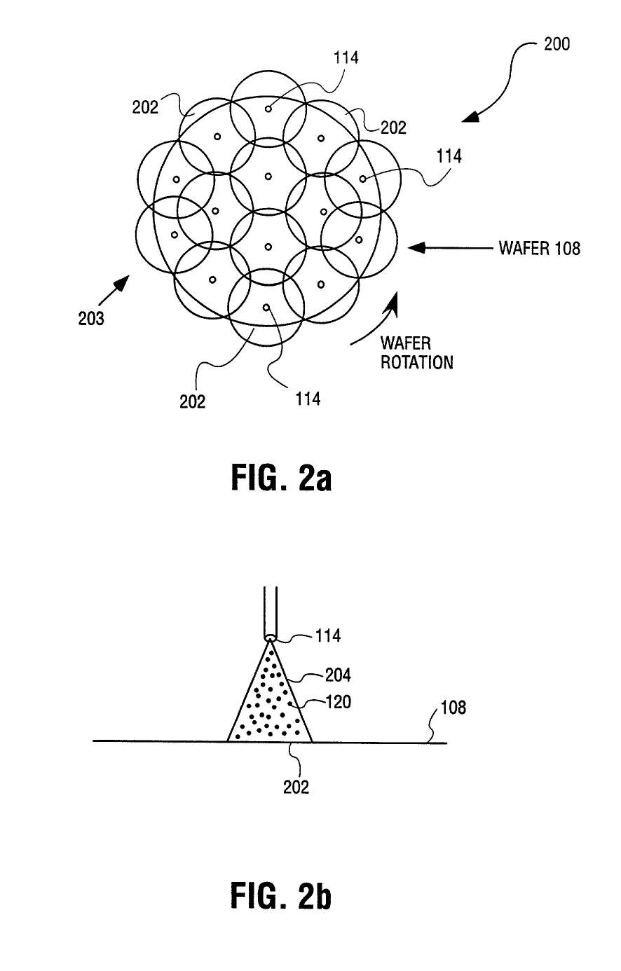

An example of a nozzle configuration 200 in accordance with a preferred embodiment of the present invention is shown in FIG. 2a. According to the preferred embodiment of the present invention a plurality of nozzles 114 are fixedly positioned over wafer 108 during processing. Each nozzle 114 creates an individual spray pattern 202 of small liquid droplets over wafer 108. Nozzles 114 are suitably located so that the combination of the individual spray patterns 202 create a combined or collective spray pattern 203 which covers the entire surface area of wafer 108. In an embodiment of the present invention the individual nozzles 114 are conical nozzles which create a cone 204 of liquid droplets or spray as shown in FIG. 2b which in turn create a circular spray pattern 202 on a portion of wafer 108. In an embodiment of the present invention 14 conical nozzles 114 are suitably positioned to create a collective spray pattern 203 which covers the entire surface of a 300 mm wafer.

By choosing and positioning spraying nozzles which create a spray pattern which covers the entire wafer surface even without spinning the wafer, the present invention is able to achieve a high uniformity wet etching such as diluted HF or buffered HF etch, even when performing a very short etch, of for example, 5-10 seconds. Additionally the nozzle configuration 200 enables a high uniformity short period etch to be carried out on a large (e.g., 300 mm) surface area wafers. The present invention is able to obtain high uniformity because the whole wafer surface receives essentially the same exposure time to chemicals. In the preferred embodiment of the present invention there is less than a 0.015 second difference in exposure between any two wafer locations enabling a high uniform etch. Additionally, because the present invention utilizes a full wafer spray coverage, the chemical consumption can be reduced. It is to be appreciated that single wafer etchers which utilize a single nozzle for dispensing chemicals rely upon dilute concentration of chemicals and long exposure times to obtain uniformity. This makes chemical consumption high because during exposure, chemicals are continually spun off the wafer. Additionally, in single wafer processes with a single nozzle the wafer must be spun at a high rotation rate in order to spread the chemical quickly over the wafer surface. Chemical consumption is increased with high rotation rates because, in such a case, the chemicals are spun off the wafer before they are able to react with the wafer surface. In the preferred embodiment of the present invention since the entire wafer surface is covered with chemicals the wafer can be spun at a low rate, between 10-100 rpm. Since rotation is not necessary to deliver chemicals across the wafer surface in the present invention chemical consumption can be reduced.

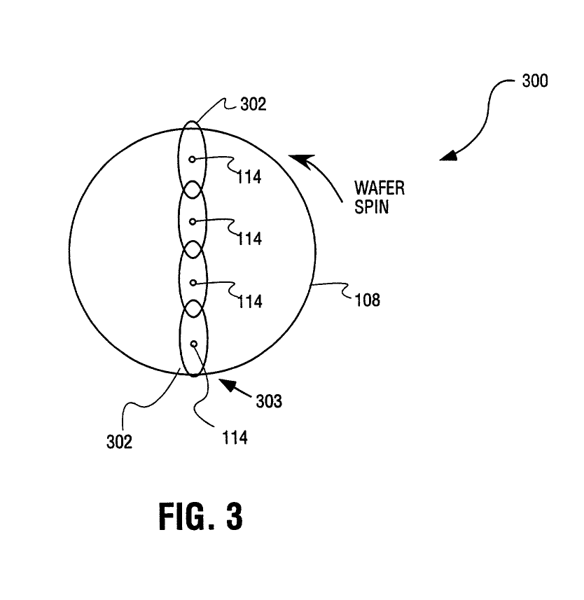

In an alternative embodiment of the present invention, a nozzle configuration 300 producing a line coverage can be used as shown in FIG. 3. The nozzle configuration 300 creates a collective spray pattern 303 which covers the entire wafer 108 diameter. In this embodiment of the present invention a plurality of nozzles 114 are fixedly positioned in the linear fashion over wafer 108 as shown in FIG. 3. Each nozzle 114 creates an individual spray pattern 302 over a portion of the diameter of wafer 108. Nozzles 114 are suitably located so that individual spray patterns 302 create a combined or collective spray pattern 303 which extends across the entire wafer diameter. In an embodiment of the present invention nozzles 114 are flat spray nozzles which form an elliptical spray pattern 302 on wafer 108 as shown in FIG. 3. When using a line coverage nozzle configuration 300 instead of full coverage, the wafer will be fully covered after a one-half rotation. In order to have less than 0.015 second difference of exposure on any point of the wafer, during initial dispensing, the wafer should be rotated at a rate of at least 2000 rpm. After the initial coverage, the wafer rotation can be reduced.

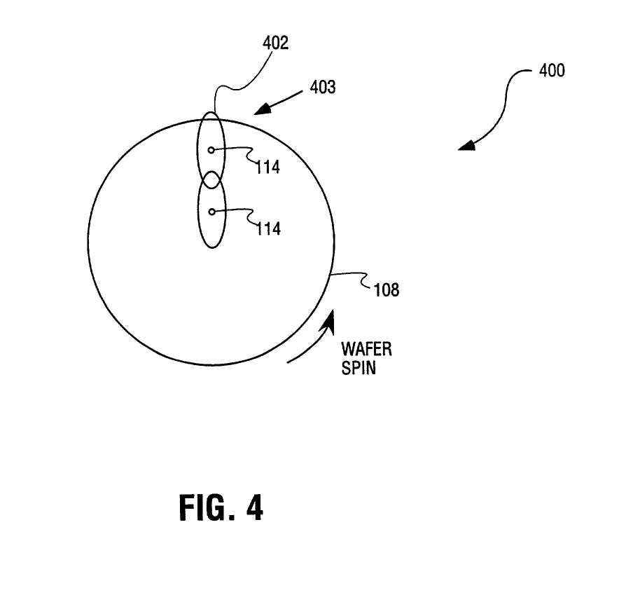

In alternative embodiment of the present invention a nozzle configuration 400 can be used as shown in FIG. 4 which forms a line cover over the entire wafer radius. In this embodiment of the present invention a plurality of nozzles 114 are fixedly positioned in a linear fashion over wafer 108 as shown in FIG. 4. Each nozzle 114 creates an individual spray pattern 402 over a portion of the radius of wafer 108. Nozzles 114 are suitably located so that the individual spray patterns 402 create a combined or collective spray pattern 403 which extends across the entire wafer radius as shown in FIG. 4. In an embodiment of the present invention nozzles 114 are flat spray nozzles which form an elliptical spray pattern 402 on wafer 108 as shown in FIG. 4. When a nozzle configuration 400 is used which creates a line coverage of the radius of the wafer, in order to have less than 0.015 second difference in exposure on any point of the wafer, the wafer should be rotated during initial dispensing at a rate of at least 4000 rpm.

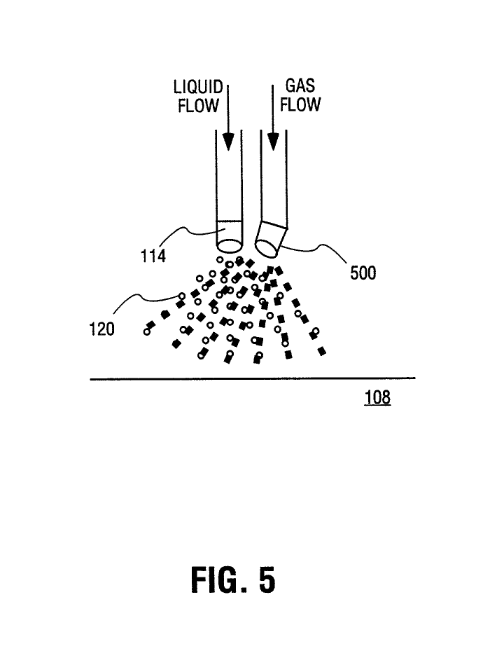

Additionally, in an embodiment of the present invention in order to increase spray coverage and make the spray droplets smaller (i.e., to atomize the liquid spray even more) a gas, such as but not limited to H₂ or N₂, is added to the liquid flow. The gas can be added prior to the nozzle opening, or two different nozzles can be used, one for the gas and one for the liquid. For example, as shown in FIG. 5 in an embodiment of the present invention for each nozzle 114 used to spray a liquid on wafer 108 there is an associated gas supply nozzle 500 which directs a flow of gas, such as but not limited to N₂ or H₂, into the liquid spray 120 which enhances the atomization of the liquid spray.

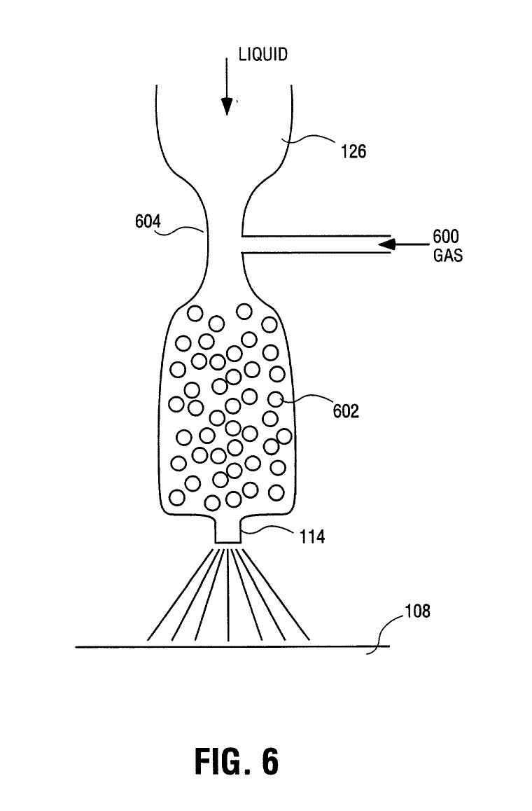

Additionally, in an alternative embodiment of the present invention as shown in FIG. 6 a gas 600, such as H₂ or N₂ is dissolved as bubbles 602 into the liquid flowing through a liquid supply line 126 prior to the liquid reaching nozzle 114. In an embodiment of the present invention a venturi 604 is used to dissolve gas into the liquid supply line 126 prior to nozzle 114. A venturi 604 is a reduced cross-sectional area of the supply conduit which creates under pressure locally because of the increased flow rate of the venturi. Venturi 604 enables gas to be dissolved into the liquid flow at gas pressures less than the pressure of the liquid flowing through the supply line. An advantage of fine atomization of the liquid spray is that a larger area can be more uniformly covered with one spray nozzle and chemical consumption can thereby be reduced. The chemical consumption can be reduced since only the chemical contacting the surface of the wafer is active. The layers of chemical on the top of this active chemical layer are not active and should be reduced to reduce the chemical consumption. The use of a fine atomization allows a very thin, as thin as 100 microns, chemical layer to be formed on the surface and therefore reduces chemical consumption.

Thus, novel spray configurations have been described as well as their use in a single wafer wet processing apparatus.

We claim:

1. A single wafer processing apparatus comprising:
a rotatable wafer support for rotating a wafer about its central axis; and
a plurality of liquid spray nozzles for creating a spray pattern of liquid onto a wafer located on said wafer support wherein said entire surface of said wafer is covered with said spray pattern.

2. The apparatus of claim 1 wherein said plurality of liquid spray nozzles are conical spray nozzles.

3. The apparatus of claim 2 wherein there are 14 conical spray nozzles.

4. The apparatus of claim 1 wherein said wafer has a 300 mm diameter.

5. The apparatus of claim 1 further comprising a plurality of gas nozzles adjacent to each of said liquid spray nozzles for directing a gas flow towards the liquid spray of said plurality of liquid spray nozzles.

6. The apparatus of claim 1 further comprising a venturi placed in a liquid supply line prior to said liquid spray nozzle for dissolving a gas in said liquid spray.

7. A single wafer processing apparatus comprising:
a rotatable wafer support for rotating a wafer about its central axis; and
a plurality of liquid spray nozzles linearly positioned to create a spray pattern of liquid which covers the entire diameter of a wafer placed on said wafer support.

8. The apparatus of claim 7 wherein said liquid spray nozzles are flat spray nozzles.

9. The apparatus of claim 7 further comprising a plurality of gas nozzles adjacent to each of said liquid spray nozzles for directing a gas flow towards the liquid spray of said plurality of liquid spray nozzles.

10. The apparatus of claim 7 further comprising a venturi-placed in a liquid line prior to said plurality of liquid spray nozzles for dissolving a gas in said liquid prior to said spray nozzles.

11. A single wafer processing apparatus comprising:
a rotatable wafer support for rotating a wafer about its central axis; and
a plurality of liquid spray nozzles linearly positioned to create a spray pattern of liquid which covers the entire radius of a wafer placed on said wafer support.

12. The apparatus of claim 11 wherein said liquid spray nozzles are flat spray nozzles.

13. The apparatus of claim 11 further comprising a plurality of gas nozzles adjacent to each of said liquid spray nozzles for directing a gas flow towards the liquid spray of said plurality of liquid spray nozzles.

14. The apparatus of claim 11 further comprising a venturi-placed in a liquid line prior to said plurality of liquid spray nozzles for dissolving a gas in said liquid prior to said spray nozzles.

15. A method of processing a wafer comprising:
rotating a wafer about its central axis; and
creating a spray pattern on the surface of said rotating wafer wherein said spray pattern covers the entire surface of said rotating wafer.

16. The method of claim 15 wherein said wafer is rotated at a rate between 10-100 rpms.

17. The method of claim 15 further comprising adding a gas flow into said liquid spray pattern in order to increase the atomization of said spray pattern.

18. The method of claim 15 wherein a gas is dissolved into said liquid prior to said liquid being sprayed on said wafer.

19. A method of processing a wafer comprising:
rotating a wafer about its central axis; and
creating a spray pattern of a liquid on said rotating wafer wherein said spray pattern has an elliptical pattern and covers the entire diameter of said rotating wafer.

20. The method of claim 19 wherein said wafer is rotated at a rate of at least 2000 rpm during the initial stage of the dispense or spray.

21. The method of claim 19 further comprising adding a gas flow into said liquid spray pattern in order to increase the atomization of said spray pattern.

22. The method of claim 19 wherein a gas is dissolved into said liquid prior to said liquid being sprayed on said wafer.

23. A method of wet processing a wafer comprising:
rotating a wafer about its central axis; and
creating a liquid spray pattern of a liquid on the surface of said rotating wafer wherein said liquid spray pattern has an elliptical shape which covers the radius of said rotating wafer.

24. The method of claim 23 wherein said wafer is rotated at a rate of at least 4000 rpm during the initial stage of the dispense or spray.

25. The method of claim 23 further comprising adding a gas flow into said liquid spray pattern in order to increase the atomization of said spray pattern.

26. The method of claim 23 wherein a gas is dissolved into said liquid prior to said liquid being sprayed on said wafer.
